(19) United States
(12) Patent Application Publication
(10) Pub. No.: US 2002/0197925 A1
(43) Pub. Date: Dec. 26, 2002

(54) Composite material for protecting plastic and metallic coatings from shock and abrasion

(76) Inventor: Markus Hamulski, Gronau-Epe (DE)

Correspondence Address: Karl F. Milde, Jr., Esq., MILDE & HOFFBERG, L.L.P., 10 Bank Street - Suite 460, White Plains, NY, 10606, US

(21) Appl. No.: 10/162,831

(22) Filed: Jun. 4, 2002

(30) Foreign Application Priority Data
Jun. 6, 2001 (DE) 101 27 312.6

(51) Int. Cl. B32B 5/18; B32B 3/10; B32B 15/04; D04B 21/14; D04B 7/16; D04B 21/00; D04B 9/00; D04B 1/00; B32B 27/30; B32B 27/12; B32B 27/32; D04B 7/00; D04B 11/00; D04B 1/18; D04B 11/12; B32B 7/12; B32B 5/24

(52) U.S. Cl. 442/286; 428/138; 428/343; 442/304; 442/306; 442/315; 442/288; 442/290

(57) ABSTRACT

Tape-like composite material for protecting two or three dimensional shaped parts from shock and abrasion. The material comprises (a) a flexible carrier film of plastic, and (b) a layer of a textile, formable knitted fabric laminated with said carrier film and bonded essentially over its entire surface.

### BACKGROUND OF THE INVENTION

The invention relates to a tape-like composite material consisting of at least two layers bound together that serves to protect a two or three dimensional formed body from shock and abrasion, i.e., as transportation protection for painted automotive parts, particularly bumpers, that are under severe mechanical loads.

Painting of plastic automotive parts such as bumpers or rear-view mirror shells in the color of the automobile is presently the standard, modern industrial design for automobiles. These parts, however, are very sensitive to scratching. Particularly bumpers and rear-view mirror shells are exposed parts of an automobile that are very easily damaged.

Consequently, over the past few years attempts have been made to transfer to bumpers a special paint-compatible transport protective film. This method has been used successfully to mask freshly-painted sheet metal parts such as are described in the German Patent No. 195 32 220 A1 and European Patent No. 0 827 526 A1.

This method has proved to be problematical for bumpers, in particular, since the protective films have not fully compensated the frequent severe stress from longitudinal scrapes and light collisions during movement and parking of automobiles, and do not provide adequate protection.

### SUMMARY OF THE INVENTION

The principal objects of the present invention are to provide a tape-style composite material that is first, easily applied to two or three dimensional objects with convex surfaces, and second, is waterproof against water and automotive fluids such as gasoline, Diesel fuel, and brake fluid. The composite material should provide a high degree of abrasion resistance combined with excellent mechanical protection which is easy on the paint such that no damage occurs even under extreme conditions.

These objects, as well as other objects which will become apparent from the discussion that follows, are achieved, in accordance with the present invention, by providing a tape-like composite material which comprises:

(a) a flexible carrier film of plastic, and

(b) a layer of a textile, formable knitted fabric laminated with said carrier film and bonded essentially over its entire surface.

The two or three dimensional objects to which the composite material may be applied, using adhesives or electrostatic methods, include those with painted surfaces such as automobiles, furniture, electrical appliances, electronic entertainment devices, computers, and similar objects. The composite material may also be suitable for wrapping.

In an advantageous embodiment, the composite material comprises a UV-stabilized polyolefin, non-oriented film as a carrier material, whereby this carrier film includes a tension elasticity modulus of less than 300 N/mm², preferably less than 150 N/mm², and a thickness from 10 to 150 μm, preferably of from 40 to 100 μm.

The carrier film is laminated with a knitted fabric that preferably possesses a basis weight of from 10 to 200 g/m², preferably of from 20 to 80 g/m².

Suitable materials for the carrier film are principally all polymer materials from which films with a low modulus of elasticity such as polyolefins, polyurethanes, or soft PVC may be manufactured.

Low-density polyolefins with which a relatively low elasticity modulus is achievable are preferred for invention use. For this, various co-polymers of ethylene with α-olefins such as propylene, 1-butene, 1-hexene, or 1-octene (predominantly LLDPE, VLDPE, ULDPE), but also ethylene-styrol co-polymers and co-polymers of propylene with ethylene and α-olefins may be considered, along with EPDM and EPM gum elastic. Saturated synthetic gum elastics such as polyethylene vinyl acetate (EVM), hydrated nitrile rubbers and synthetic gum rubbers containing styrol, such as SEBS and SEPS, are also well-suited, since these offer good weathering resistance, in contrast to unsaturated variants including natural gum rubber. Further, polymers containing halogen such as chlorinated polyethylene or chloroprene may be used. Mixtures of various suitable polyolefins are preferably used in order to adjust the mechanical and thermal properties and workability and other application parameters.

In order further to increase the softness of a suitable material and the resistance to shock loads, the film may also be foamed in addition.

The addition of light-protective medium is preferred in order to provide the proper weathering resistance to the carrier film. Their function is primarily to prevent brittleness of the carrier surface. Such types of light-protective media are described by Gaechter and Mueller in Taschenbuch der Kunststoff-Additive, (Plastic Additives Handbook) Munich, 1979, by Kirk-Othmer (3^{rd} Ed.) 23, pp 615-627, by Encyl. Polym. Sci. Technol. 14, pp 125-148, and by Ullmann (4^{th} Ed.) 8, 21; 15, 529, 676. In particular, HALS light protection media are suitable for the protective film based on the invention.

The amount of light-protective media should be at least 0.15% by weight, and preferably 0.30% by weight, with respect to the carrier film. An additional improvement of the carrier film's light stability is also possible through the addition of titanium dioxide. Regarding mechanical properties and homogeneity of the brightness, 5 to 15% of titanium dioxide additives is advantageous. The UV permeability of the protective film in the thickness range of 290 to 300 nm by means of the interaction of light protective media and pigments preferably lies below about 1%, and preferably below about 0.1%.

The film may also be pigmented with color for appearance reasons.

It may be advantageous for painted plastic parts with a high degree of solvent retention in the paint partially caused by low dry temperatures to perforate the base film for the purpose of improved gas permeability.

The addition of anti-block materials such as chalk or talcum may be advantageous for reasons of better workability, particularly in the blown film process. Such a film may also be produced using the flat film extrusion process, or by calendering. The film itself may thus be made up of individual layers.

Knitted fabrics are textile surface-formed bodies produced from one or more fibers or fiber systems by means of loop formation (fiber looping), in contrast to woven fabric (cloth) in which the surface is produced using interlacing of two fiber systems (chain and weft fibers), and to fleece (fiber composite materials in which a loose fibrous web is reinforced using heat, needle felting, stitching, or water streams). Knitted fabrics include weft knitted fabric, knitted goods, or knits.

Knitted fabrics may be divided into knitted fabrics in which the fibers extend through the textile along the cross direction, and into knitted fabrics in which the fibers extend longitudinally through the textile. Knitted fabrics are usually principally flexible, elastic textiles by virtue of their knitted structure because the stitches may expand both in length and in width, and have the tendency to return to their original shape. They are very wear-resistant in high-cost materials.

The knitted fabric should preferably have a basis weight of 10 to 200 g/m², especially from 20 to 80 g/m², in order to ensure good elasticity even when combined with blown film. The most suitable are types that are particularly wear-resistant and resistant to shock loads in combination with the elastic blown film.

Examples of suitable fiber raw materials are synthetic filaments (fibers or strips) made of polymerides such as polyethylene, polypropylene, or a mixture of them, polyvinyl chloride, polyvinylidene chloride or polyacrylnitrile, polycondensates such as polyamide, aramide, or polyester. Semi-synthetic fibers such as cotton, rayon staple fiber, wool, or silk, and composite fabrics may also be used.

The excellent water resistant, synthetic, thermoplastic fibers—polyamide, polyester, or polyethylene—are preferred for use. These withstand semi-annual outdoor exposure adequately, but may be UV-stabilized if necessary, either by incorporation of the stabilizer into the fibers or by treatment of the knitted fabric with light-resistant impregnation. Suitable light-resistant materials are discussed in the same source as is the issue of film stabilization.

Solvent-free laminate adhesives, particularly reactive ones, may be used in order to combine the knitted fabric with the carrier film. Such adhesives include aromatic or preferably aliphatic polyurethane adhesive. Any conventional thermal melt, dispersion, or solvent adhesive such as polyacrylate, polyethylene vinyl acetate, or an epoxy resin system is also suitable to the extent that they offer the required outdoor exposure resistance.

The carrier film may also be combined with the knitted fabric without adhesives, depending on the material. In the case of flat film extrusion of lower-density polyolefins, one may extrude the film onto the knitted fabric and combine it there by melting.

Suitable fillers and pigments include lampblack, titanium dioxide, calcium carbonate, zinc carbonate, zinc oxide, silicates, or silicic acid.

The combination of flexible knitted fabric and film with low tension elastic modulus creates excellent resistance to friction and light impact that exceeds that of a fabric with similar surface weight. The composite material is highly impervious to fluids and their paint-damaging effects.

In the following, the invention is described using examples without being limited to them.

### EXAMPLES

### Example 1

A 50-μm thick blown film composed of 84.7 parts by weight of a co-polymer produced of ethylene and octane using metallocene catalytic converters and with a density of 0.902 g/cm² (PE-VLD), with a tension E-modulus of 55 N/mm², a molten flow rate at 190° C./2.16 kg (ISO 1133) of 1 g per 10 minutes, for which the mass to be extruded has 5 parts by weight of titanium dioxide, 10 parts by weight of chalk, and 0.3 parts by weight of light-protective material Tinuvin 770 (Ciba-Geigy) was laminated using a solvent-free laminate adhesive based on polyurethane (manufacturer: HENKEL, Duesseldorf) with a knitted fabric of polyamide 6/6.6 with a knit count of 10 knits/cm along the material travel direction and 14 knit rows along the cross direction and with a basis weight of 40 g/cm².

### Example 2

The composite material corresponds to that in Example 1, but, in contrast, uses a 70-μm thick three-layer blown film made of two 10-μm thick outer layers and a 50-μm thick inner layer. The outer layers consist of 84.7 parts by weight of co-polymerisates of ethylene and octane produced using metallocene catalytic converters with thickness of 0.890 with a tension E-modulus of 40 N/mm², a molten flow rate at 190° C./2.16 kg. 5 parts by weight of titanium dioxide, 10 parts by weight of chalk, and 0.3 parts by weight of light-protective material Tinuvin 770 (Ciba-Geigy) were combined (lamintaed). The inner layer consisted of 99.7 parts by weight of polypropylene co-polymer with other olefins, with a density of 0.890 and a molten flow rate at 230° C./2.16 kg (ISO 1133) of 0.6 g/10 min and a tension E-modulus of 80 N/mm².

### Example 3

A film-knitted fabric laminate similar to that described in Example 1 was treated after lamination with a needle roller with 15 conical needles/cm². The diameter of the holes was set to 1 mm by means of the needle binding ring depth.

### Example 4

A composite material similar to that in Example 1 but differing in that a knitted fabric of polyamide 6/6.6 with a basis weight of 60 g/m² and with a knit count of 14 knits/cm along the material travel direction was used. The chain knit of the type used here also had 14 knit rows along the cross direction.

### COMPARISON EXAMPLE 1

The composite material is similar to that in Example 1, but differs from it in that, instead of the film described there, a 50-μm thick HDPE film with a density of 0.963 g/cm² and with a molten flow rate at 190° C./2.16 kg (ISO 1133) of 0.2 g/10 min and a tension E-modulus of 800 N/mm².

### COMPARISON EXAMPLE 2

The composite material is similar to that in Example 1, but differs from it in that no knitted fabric was laminated to the base film.

### TEST CRITERIA

Three particularly relevant application criteria for a composite material for plastic automotive parts were selected for a comparative evaluation of the example samples:

(1) Susceptibility to creasing

(2) Resistance to abrasion

(3) Protection of the plastic part against chemical reagents such as battery acid

Samples of the self-adhering composite material 30 cm long and 15 cm high were attached to painted bumpers selected for test application whose corner parts have strong three-dimensional relief.

### TESTING PROCEDURE

### 1. Susceptibility to Creasing

During attachment, the sample was applied with as few creases as possible to the three-dimensional bumper corner. Evaluation of susceptibility to creasing was according to the following system:

0=no creases

1=isolated creases

2=some creases

3=numerous creases

The susceptibility to creasing is a measure of anticipated damage to the paint under concave locations by potential water dispersion under humid conditions, and of visible imprints resulting from wetting angle effects.

### 2. Abrasion Resistance

The sample was applied to a metal plate and was abraded in an abrasion test device with a round abrader loaded with 3 kg at a frequency of 1 Hz until the abrader came into contact with the metal plate.

Evaluation system:

0=more than 400 cycles

1=250 to 400 cycles

2=100 to 200 cycles

3=fewer than 100 cycles

### 3. Resistance to Chemical Reagents

Using a pipette, 1 ml of battery acid was dripped onto a sample covering a painted surface. Subsequently, the sample and paint layer was immediately stored for 30 minutes at 80° C. Finally, the sample was removed, and the paint under it was examined for damage.

Evaluation system:

0=not visible

1=barely visible

2=faintly visible

3=clearly visible

Review of results

A low overall point count (Column Σ) signifies a good overall evaluation.

TABLE

| | Suscepti- | | | |
|---|---|---|---|---|
| | bility to | | Resistance | |
| | creasing | | to | |
| | on 3D | Abrasion | chemical | |
| | surface | resistance | reagents | Σ |
| Example 1 | 0 | 0 | 0 | 0 |
| Example 2 | 0 | 0 | 0 | 0 |
| Example 3 | 0 | 0 | 1 | 1 |
| Example 4 | 0 | 0 | 0 | 0 |
| Comparison | 3 | 0 | 0 | 3 |
| Example 1 | | | | |
| Comparison | 0 | 3 | 0 | 3 |
| Example 2 | | | | |

The evaluation clearly shows that the product structure based on the invention achieved excellent results from the critical tests.

In contrast to the comparison examples, the examples deal with paint-compatible, conforming, liquid-tight, and exceptionally abrasion-resistant composite materials that are thus well suited for providing reliable protection and value preservation to plastic automotive parts and other objects.

There has thus been shown and described a novel composite material for protecting plastic and metallic coatings from shock and abrasion which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. Tape-like composite material for protecting two or three dimensional shaped parts from shock and abrasion, said material comprising:
(a) a flexible carrier film of plastic, and
(b) a layer of a textile, formable knitted fabric laminated with said carrier film and bonded essentially over its entire surface.

2. Tape-like composite material as set forth in claim 1, wherein the carrier film possesses an elasticity modulus of less than 300 N/mm².

3. Tape-like composite material as set forth in claim 1, wherein the carrier film possesses an elasticity modulus of less than 150 N/mm².

4. Tape-like composite material as set forth in claim 1, wherein the carrier film possesses a thickness of 10 to 150 μm.

5. Tape-like composite material as set forth in claim 1, wherein the carrier film possesses a thickness of 40 to 100 μm.

6. Tape-like composite material as set forth in claim 1, wherein the carrier film is made of a material selected from the group consisting of polyolefins, polyolefin mixtures, polyurethane, and soft PVC.

7. Tape-like composite material as set forth in claim 1, wherein the carrier film contains more than 0.15% by weight of a light protection stabilizer.

8. Tape-like composite material as set forth in claim 1, wherein the carrier film contains more than 0.3% by weight, of a light protection stabilizer.

9. Tape-like composite material as set forth in claim 1, wherein the carrier film is perforated.

10. Tape-like composite material as set forth in claim 1, wherein the carrier film is foamed.

11. Tape-like composite material as set forth in claim 1, wherein the knitted fabric is selected from the group consisting of a weft knitted fabric, knitted goods, and a knit.

12. Tape-like composite material as set forth in claim 1, wherein the knitted fabric possesses a basis weight in the range of from 10 to 200 g/m².

13. Tape-like composite material as set forth in claim 1, wherein the knitted fabric possesses a basis weight in the range of from 20 to 80 g/m².

14. Tape-like composite material as set forth in claim 1, wherein the knitted fabric is made of a material selected from the group consisting of polyamide, polyester, and polyethylene filaments (fibers or strips).

15. Tape-like composite material as set forth in claim 1, wherein the knitted fabric is single-layer.

16. Tape-like composite material as set forth in claim 11, wherein the carrier film is bonded with the knitted fabric by means of a laminate adhesive.

17. Tape-like composite material as set forth in claim 16, wherein the carrier film is bonded with the knitted fabric by means of binary-component polyurethane.

18. Process of using the tape-like set forth in claim 1, comprising the step of applying the tape-like material to two or three dimensional formed parts to cover, protect, or package said parts.

19. The process define din claim 18, wherein said formed parts are painted automotive parts.
